(19) United States
(12) Patent Application Publication
(10) Pub. No.: US 2016/0019590 A1
(43) Pub. Date: Jan. 21, 2016

(54) INFORMATION DISPENSING SYSTEM

(71) Applicant: Simon Gerard Coyle, Folsom, CA (US)

(72) Inventor: Simon Gerard Coyle, Folsom, CA (US)

(21) Appl. No.: 14/489,232

(22) Filed: Sep. 17, 2014

Related U.S. Application Data
(60) Provisional application No. 61/999,165, filed on Jul. 18, 2014.

(51) Int. Cl. G06Q 30/02; G06F 17/30

(52) U.S. Cl. CPC G06Q 30/0257; G06Q 30/0267; G06F 17/30879

(57) ABSTRACT

Disclosed is a system for providing target information such as the location of a vehicle in a parking garage, the sales information about property for sale (such as real estate or vehicles) transportation information (such schedules and routes of trains, buses and planes). The system includes a smart sign having a sign code for use in accessing target information for an item at an identified location. The system also includes a smart device for inputting the sign code, for transmitting the sign code to a remote server, and for receiving a reply from the remote server to provide the target information.

### BACKGROUND OF THE INVENTION

This invention relates to information dispensing systems such as needed to identify locations of parked cars, identify details of real estate for sale, identify details of cars and other vehicles for sale, identify features and attractions of cities and towns and identify transportation information for trains, buses and airlines. These examples of information dispensing are only illustrative and many other types of information dispensing are included.

By way of example, drivers often forget the location where they had parked their vehicle and hence upon return need information to help them find the vehicle. This is a frequent problem, especially in large multi storied parking garages. In this event, drivers have to either walk a long distance in the parking garage till they locate their vehicle; or they have to request the services of a parking attendant or a friend to drive them in the parking garage to locate their vehicle. Parking garages have come up with many innovative solutions to help drivers remember the location of their parked vehicle; 1) some have unique color schemes for each parking level; 2) some have easy to remember names for each parking level; 3) some have fliers at each level with the corresponding parking level printed on them that drivers can take with them; 4) some print their map and layout on the back of parking tickets, on which drivers can mark the location of their parked vehicle. However there are many drawbacks with each of the present methods used by parking garages; 1) there is no uniformity in the method used, with each parking garage having its own unique method; 2) most methods only help drivers remember the level on which their vehicle is parked and not its exact location; 3) many methods consume paper which is environmentally unfriendly; 4) the methods employing unique color schemes or unique names for each parking level still require driver to memorize them, which can be problematic, especially in case of older drivers and drivers who park their vehicles for longer periods of time; 5) some methods require drivers to write the location of their parked vehicle which can be a problem on many accounts; a) requires drivers to carry a writing instrument, which is not the case at all times; b) some elderly drivers have trouble writing because of poor vision, arthritis in their hand joints or neuromuscular disorders; c) sometimes lighting conditions in the parking garage is not optimal.

The prior art for vehicle location is comprised of devices which follow three basic types of utilization.

In the first type, the vehicle parker may attach to the vehicle a device which will make seeing the vehicle from a distance easier. Example of this type include flashing lights, sound-emitting devices such as horns or buzzers, flags or lights on extendible arms, and the such. These devices is activated manually upon exiting the vehicle or automatically when the parker returns to the vicinity of the vehicle. In the former, the vehicle parker turns on a flashing light or raises a flag; in the latter case a vehicle seeker presses a button on a small transmitter and when the signal is received by the device, a light turns on, an alarm sounds, or the flag is raised automatically. Patents in this type include: (i) U.S. Pat. No. 6,246,314; (ii) U.S. Pat. No. 6,239,701; and (iii) U.S. Pat. No. 5,933,081. This prior art does not practically serve the needs of the parked vehicle seeker.

The major problem with the first type of devices is that they require that the parked vehicle seeker must already be in the vicinity of the parked vehicle for the device to work. If a parked vehicle seeker is not already within line of sight or hearing of the vehicle, the device will not be able to guide the seeker, which is the purpose. Thus, the devices in this type will work only if a person already remembers most of the parking location information.

The second type of prior art utilizes an electronic or mechanical hand-held device into which the vehicle parker may manually enter identifying criteria for the parking space as the garage or lot may provide. This data may include a color code, or a space number and floor number. The device is a simple paper card with manually selectable markings designating parking locations, or more technologically advanced mechanical or electronics product which the user manipulates to record vehicle location. Examples from the prior art of this type include: (i) U.S. Pat. No. 4,881,758; (ii) U.S. Pat. No. 5,190,319; (iii) U.S. Pat. Nos. 6,114,953, 6,400,358; (iv) U.S. Patent No. 2001/0045896; and (v) U.S. Patent No. 2002/0008614.

In addition, In U.S. Pat. No. 6,400,358 issued on Jun. 4, 2002; Carter has disclosed a portable electronic parking location reminder device that is easily carried on a key chain or key ring has an electronic display screen and contains a battery powered microcontroller with memory and timer features. User input keys on the housing allow the user to enter letters and/or numbers corresponding to the location of a parked vehicle, store the entered data, and later retrieve and display the data when it is desired to find the parked vehicle. The user input keys include a mode key for selecting between an alpha mode for entering letters of the alphabet (A-Z), a numeric mode for entering numerals (09), and a direction mode for entering letters representing geographical directions (N, NE, E, SE, S, SW, W,). Data is entered and displayed in several distinct fields that correspond to an aspect of the location of the parked vehicle. The identity of a parking lot in which the vehicle is parked is entered in a first field, the identity of a row of a parking area entered in a second field, the identity of a floor level of a parking facility in a third field, and the identity of a geographical location of a parking area in a fourth field. Stored data is selectively locked to prevent accidental changing. An automatic reduced power mode reduces power consumption when not in use and a low battery condition is also displayed.

In addition, there are inventions in the prior art that have attempted to provide a suitable device with means to remind drivers of the location of their parked vehicle. In U.S. Pat. No. 6,529,142 issued on Mar. 4, 2003; Yeh et al have disclosed a system for locating a vehicle that is parked in a parking lot, a parking garage or on a street. The system comprises of two separate signal generator/processor circuits, each circuit being contained in a module, one being a hand-held locator module and the other, a receive/response module that is installed in a vehicle. Both modules, when activated by user, communicate with the other by means of specially encoded radio signals. To find a parked vehicle, a user merely presses a pushbutton on the locator module which transmits a high frequency search signal. In response, the receive/response module emits a direction indicating signal to the locator module, which then displays the direction and elevation of the vehicle with respect to the user location. Provision is made for the receive/response module to operate without a connection to a vehicle battery if necessary, allowing the module to be used portably. The system is small in size, inexpensive and easy to use.

The prior art in the second type is deficient in that they require that the parking vehicle seeker must carry an additional device with them in order to record the data. Either the parker must carry an additional pen or pencil, key-chain, keypad, or mechanical roller to enter the data, or purchase some other hand-held device to record the data. These extra purchases are cumbersome for the user. Further, in the case of cards which is “scratched-off,” the cards must be redesigned to accommodate the parking scheme of every garage, and changed to accommodate every change in scheme, and this is economically detrimental for the owner of the garage or lot. A further deficiency of the second type is that they do not permit garage and lot owners and operators to change their lot constructions methods to take account of new parking lot technologies. If a new technology arises, the old devices will become obsolete.

The third type of prior art utilizes the system of global positioning satellites to locate a vehicle. In this type, vehicles will be equipped with transceivers which emit a signal, and the parker of the vehicle will carry a second transceiver which relays the location of the vehicle and displays directional arrows which would direct the seeker towards the vehicle. For example, in U.S. Pat. No. 6,489,921 issued on Dec. 2, 2002; Wilkinson has disclosed a system for locating a parked vehicle, as in the case of a driver having forgotten the location of his/her parked vehicle in a crowded parking lot, whereby a handheld apparatus is automatically engaged prior to the driver leaving the immediate vicinity of his/her parked vehicle. When thusly engaged, the apparatus retrieves GPS location coordinates for the parked vehicle from GPS satellites and stores these coordinates in its memory. Once activated by the driver for the purpose of finding his/her parked vehicle, the Vehicle Locating Apparatus retrieves GPS location coordinates for the driver's current position. Using the GPS location coordinates stored in its memory and those retrieved for the driver's current location, a microprocessor contained within the apparatus calculates the shortest course between the driver and his/her parked vehicle. This course is then presented on a visual display by way of a “floating” directional arrow.

In the case of a parking garage where GPS satellite signals cannot be retrieved consistently, the apparatus has a built in counting switch that allows the driver to manually record in the apparatus' memory the floor number on which he/she parked his/her vehicle. When requested, the apparatus displays the floor number on a visual display. The prior art in the third type is deficient in that it relies on a technology which is unreliable within concrete or underground parking structures. In this type, the only device which would be powerful enough to utilize GPS technology from within a large concrete structure, and/or underground, would be too large and expensive to be of practical use to the common parker, and so of limited commercial benefit.

A major deficiency of all three types of prior art is that they put the onus of providing a vehicle locating system on the parker of the vehicle. This is just one more requirement for the vehicle parker, when that person will be thinking about shopping, a business engagement, taking care of a little child, and the like.

Finally, all three types are deficient in that they do not actively provide a flexible and efficient means for the owner of the garage or lot to increase their revenue base. The current invention solves this deficiency by providing a means for the garage owner to sell advertisements through the system and so turn a revenue neutral facility into a revenue generating facility.

U.S. Pat. No. 8,325,063 issued Dec. 4, 2012 a computer and system for recording electronic data about parking spaces and payments therefor.

U.S. Patent 2005/0228583 describes parking locator facilities with the addition of advertising, promotion coupon distribution and other printed information.

While the above background focused on parking vehicles and vehicle location, it is representative of the general category of information dispensing.

In consideration of the above background, there is a need for improved information dispensing systems.

### SUMMARY

The present invention is a system for providing target information such as the location of a vehicle in a parking garage, the sales information about property for sale (such as real estate or vehicles) transportation information (such schedules and routes of trains, buses and planes). The system includes a smart sign having a sign code for use in accessing target information for an item at an identified location. The system also includes a smart device for inputting the sign code, for transmitting the sign code to a remote server, and for receiving a reply from the remote server to provide the target information.

In some embodiments, the sign code includes one or more of a Q-code, a bar code and a text code.

In some embodiments, the smart device is a smart phone, the transmission of the sign code is by a sent text transmission and the receiving of the target information is by a received text transmission.

In some embodiments, the transmitting and receiving operations can be substantially delayed from the inputting operation. The transmitting and receiving operations occur only when the smart device is able to communicate with the remote server.

In some embodiments, the target information includes a link for accessing further information.

In some embodiments, the smart sign is in a parking garage and the identified location is a parking stall for a vehicle.

In some embodiments, the smart sign is in a parking garage, the identified location is a parking stall for a vehicle and the target information includes a Web link for merchants interested in drivers parking in the parking garage.

In some embodiments, the smart sign is with a real estate sign for property at the identified location and the target information provides details about the real estate.

In some embodiments, the smart sign is with a vehicle at the identified location and the target information provides details about the vehicle.

In some embodiments, the smart sign is for transportation at the identified location and the target information provides details about the transportation. The foregoing and other objects, features and advantages of the invention will be apparent from the following detailed description in conjunction with the drawings.

### BRIEF DESCRIPTION OF THE DRAWINGS

FIG. 1 depicts a block diagram of a system for providing target information.

FIG. 2 depicts one type of encoded data for use on a smart sigh with the FIG. 1 system.

FIG. 3 depicts text data for use for use on a smart sigh with the FIG. 1 system.

FIG. 4 depicts a one sequence of operations of the FIG. 1 system.

FIG. 5 depicts a typical code and texting display for texting to the server in the FIG. 1 system.

FIG. 6 depicts a returned text message in response to the transmitted message of FIG. 5

FIG. 7 depicts a first screen of data returned from the link ezrsjc.com in the message of FIG. 6.

FIG. 8 depicts a second screen of data returned from the link ezrsjc.com in the message of FIG. 6

FIG. 9 depicts a third screen of data returned from the link ezrsjc.com in the message of FIG. 6

FIG. 10 depicts encoded data for use with a real estate embodiment of the FIG. 1 system.

FIG. 11 depicts a returned text message in response to the transmitted message of FIG. 10.

FIG. 12 depicts encoded data for use with an auto sale embodiment of the FIG. 1 system.

FIG. 13 depicts a returned text message in response to the transmitted message of FIG. 12.

FIG. 14 depicts encoded data for use with a metropolitan transportation embodiment of the FIG. 1 system.

FIG. 15 depicts a returned text message in response to the transmitted message of FIG. 14.

### DETAILED DESCRIPTION

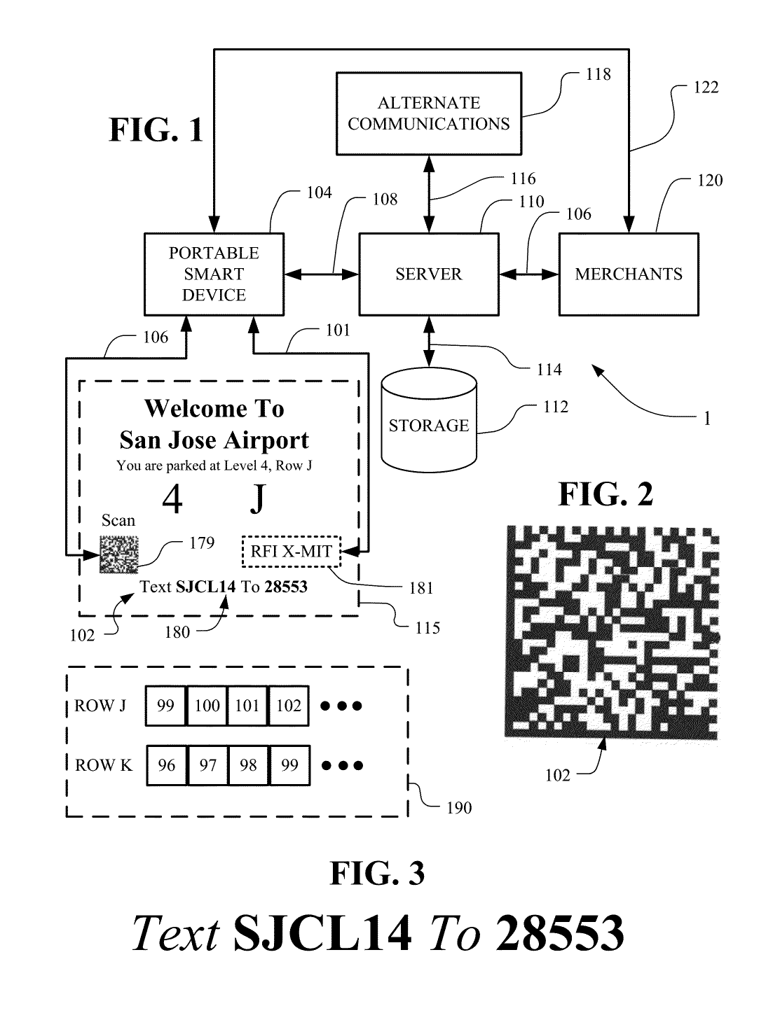

In FIG. 1, a block diagram of a system 1 is shown for receiving and processing encoded data and providing target data. In one embodiment, the system 1 operates for receiving and processing the location of one or more parking spaces in a parking area 190 such as a garage. The system includes, among other things, a parking space location sign 115, sign codes 102 associated with the parking space location, a portable smart device 104, a server 110, and storage 112. Communications paths 106 and 108 provide connectivity between portable smart device 104 and the encoded data 102 and the server 110, respectively. In addition to the encoded data 179, other encoded data is provided as text 180 in the form of SCJL14 for texting to number 28553 and an RFID transmitter 181 connecting to smart device 104 via RF link 101. The codes 179, 180 and 181 are each different representations of a sign code 102 any of which are input to the smart device 104.

The encoded data of sign codes 102, which are associated with the parking space location, are computer readable. The sign codes 102, 180 and 181 are readable by the portable smart device 104. The sign codes are in any coded form and additionally include bar codes, a dot matrix codes and any other suitable code that is readable by or imputable to the portable smart device 104. The sign codes 102 on the sign 115 are unique to one or more parking spaces such as spaces 99, 100, 101, 102 and so on in ROW J or parking spaces such as spaces 96, 97, 98, 99 and so on in ROW K. The sign codes 102 are useable to obtain information, such as location, about the parking spaces or a particular parking space within the parking area 190.

In system 1, the smart sign 115 has a sign code 102. The sign code 102 is used for accessing target information, such as vehicle location, for an item at an identified location, such as the parking space of the vehicle.

FIG. 2 depicts a type of encoded data 179 as a sign code 102 according to one embodiment. In FIG. 2, the encoded data 179 is a QR code. The QR code contains encoded data for accessing target information from the server 110

FIG. 3 depicts a type of encoded data 180 as a sign code 102 according to another embodiment. In FIG. 3, the encoded data 180 is a text message. The text message contains encoded data for accessing target information from the server 110

The portable smart device 104 is any portable electronic device capable of receiving and decoding the encoded sign code 102 in any of the forms 179, 180 and 181. In one embodiment, the portable smart device 104 is a cell phone or other mobile communication device, such as a personal digital assistant (PDA), a smart phone, or a Blackberry phone.

The portable smart device 104 is configured to receive the encoded data 102 associated with the parking space location. For example, the portable smart device 104 may have a digital imaging device, such as a digital camera or an optical scanner. The digital imaging device is contained within or be communicatively coupled to the portable smart device 104.

The portable smart device 104 may receive an encoded sign code 102 over the communications path 106. The communications path 106 is any suitable path through which the portable smart device 104 is communicatively coupled with the encoded sign code 102. In some embodiments, the communications path 106 is through optical imaging, such as through a digital camera. For example, the portable smart device 104 may receive the digital image of encoded data 102 through an optical imaging device, such as a digital camera.

After the encoded data 102 is received by the personal smart device 104, the information contained within the encoded sign code 102 is decoded. For example, the encoded sign code 102 is decoded from a machine readable format to a human readable format. The personal smart device 104 may have a decoding module for decoding the data contained within encoded sign code 102. Once the data contained within encoded sign code 102 is decoded by the portable smart device 104, the decoded data is displayed by the portable smart device 104. The displayed data may comprise the location of the parking space and a time of receipt of the encoded sign code 102. The time may originate from the portable electronic device's own clock.

In typical embodiments, the portable smart device 104 does not have a decoding module for identifying location or the sign code 102 does not contain sufficient information, by itself, to identify the location. In such embodiments communications with a server 110 are initiated. The communications are initiated upon decoding the encoded sign code 102. The portable smart device 104 may automatically initiate contact with the server 110 or may initiate contact through a manual command from the user of the portable smart device 104. Such a command is entered or selected on the portable smart device 104. Upon successful initiation of communications between the portable smart device 104 and the server 110, the portable smart device 104 is communicatively coupled with the server 110 over communications path 108. Data is exchanged between the portable smart device 104 and the server 110. Data is transmitted from the portable smart device 104 to the server 110. Data is transmitted from the server 110 to the portable smart device 104.

The data transmission over path 108 is in the form of a text message or an email. The data from portable smart device 104 may include the decoded data from the encoded sign code 102. In some embodiments, the encoded sign code 102 is transmitted to the server 110. Alternatively, a combination of both the decoded data and the encoded sign code 102 is transmitted to the server 110. The server 110 may perform processing of the data received from the portable smart device 104, such as decoding the encoded sign code 102. The server 110 may associate the data with the particular portable smart device 104 that transmitted the data. The association is done by using, for example, the phone number of the portable smart device 104, the email address of the portable smart device 104, the Internet Protocol (IP) address of the portable smart device 104, or a combination thereof. The association of the data is by any identifier that uniquely identifies the portable smart device 104 that transmitted the parking space data. The association of the data with the portable smart device 104 may allow for future access, retrieval, and processing of the data.

The communications path 108 is any suitable communications path, such as a wireless signal. The wireless signal may consist of Bluetooth, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and/or systems suitable for transmitting and receiving data from the portable smart device 104 to the server 110. The portable smart device 104 and the server 110 may use standard wireless protocols including IEEE 802.11a, 802.11b and 802.11g. The communications path 108 may also consist of the portable smart device 104 placing a cellular call to the server 110, in which case communications path 108 takes place over the appropriate cellular network which serves the portable smart device 104 and the server 110.

The server 110 may send an acknowledgement to the portable smart device 104 over the communications path 108 upon completion of the data transmission. The receipt may indicate if the transmission was successful. The receipt is displayed upon the portable smart device 104 for the user to review. The receipt may also consist of an audible tone or message, such as a text message or an electronic mail message.

In some embodiments, the encoded sign code 102 received by the portable smart device 104 is transmitted to the server 110. If the encoded sign code 102 is transmitted, the server 110 may decode the encoded sign code 102. The server 110 may decode the encoded sign code 102. The server 110 may then transmit the decoded data to the portable smart device 104 for display to the user. The display is in the same manner as if the portable electronic device performed the decoding and display functions. This option is used if the portable smart device 104 does not have the capability to decode the data itself, such as if the portable smart device 104 is an older model lacking certain capabilities of decoding a particular form of the encoded sign code 102. The server 110 may also transmit the decoded data to the portable smart device 104 in the form of a text message or electronic mail message. The decoded data transmitted from the server 110 to the portable smart device 104 may also be stored on the portable smart device 104.

The server 110 may store the data in storage 112. The data stored may consist of the decoded data, the encoded data, or a combination thereof. The server 110 may overwrite prior data from the portable smart device 104 stored in storage 112. In some embodiments, an option is presented on the portable smart device 104 to allow the prior data stored in storage 112 to be kept along with the recent data. This option is presented as a display choice on the portable smart device 104 for the user to select. For example, a person may park their automobile in an airport parking area and record the encoded sign code 102 corresponding to the parking space location they parked in. Subsequently, the person may travel to another location and obtain a rental automobile. While using the rental automobile, the person may park it in a parking area and wish to use the features of the claimed invention. This feature would allow them to do this.

A form of identification is assigned to the data received from the portable smart device 104 associating the data with that particular electronic device, e.g. the portable smart device 104. The identification is unique to permit the retrieval of the data associated with the portable smart device 104, if required, due to a failure of the portable smart device 104. The identification may consist of the phone number, the email address, or the IP address associated with the portable smart device 104. A combination of identification features is used to protect access to the data stored in storage 112. In some embodiments, a user of the embodiment may create a unique password for accessing the stored data. The form of identification is tagged to the stored data to associate the data with the portable smart device 104.

The storage 112 may consist of any suitable storage device for the data from server 110. Storage 112 may consist of one or more data storage devices.

The user of the portable smart device 104 may also initiate contact with the server 110 to retrieve the data from the particular encoded data associated with the portable smart device 104. Upon establishment of communication with the server 110, the data is transmitted from the server 110 to the portable smart device 104 for display to the user. The data may also be stored upon the portable smart device 104 after it is received from the server 110. This communication may occur over the same communication path, that is the contact with the server 110 and the transmission of data from the server 110 to the portable electronic device may occur over the same communications path.

Upon establishment of communications with the server 110, either through the communications path 108 or through the communications path 116 using alternate communications 118, the user is required to provide the identification used by the server 110 to store the data in storage 112. This identification may allow the data from the portable smart device 104 that is stored in storage 112 to be retrieved and transmitted to the user. Such identification may only be required if the communications path 116 is used since the server 110 is able to recognize the portable smart device 104 if communications path 108 is used. The form of the provided data may depend upon the method or system used to establish communications with the server 110. For example, if a toll free number is used to contact the server 110, the retrieved data is relayed to the user through an audio message containing the information from the data, e.g., the location of the parking space. The server 110 may also transmit back to the portable smart device 104 the data received from the portable smart device 104. The data is in encoded or decoded format. If the encoded data is transmitted to the portable smart device 104, the portable smart device 104 may decode the data and display the decoded data to the user. The data may also be stored on the portable smart device 104 following receipt from the server 110.

In some embodiments, the alternate communications 118 is a website. The communications path 116 can be the internet. Upon accessing an appropriate website, the user may provide the identification and the data may then be retrieved and displayed upon the computer being used to access the website.

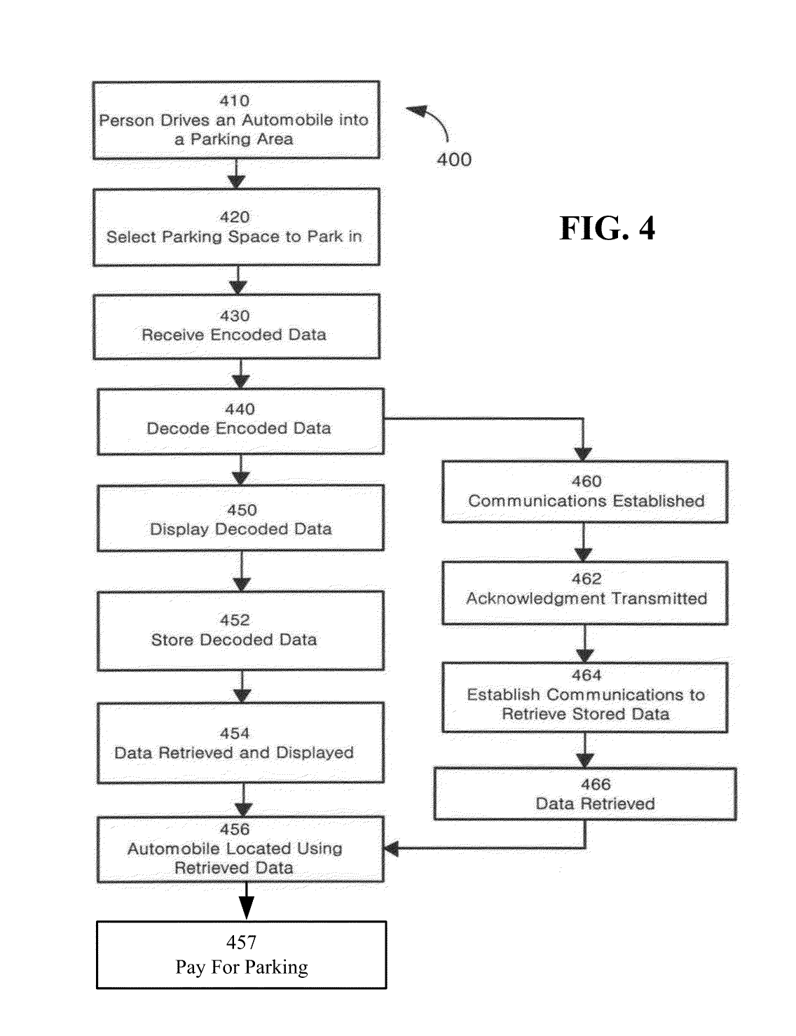

In FIG. 4, a sequence of operations of the FIG. 1 system is shown.

In 410, Person Drives an Automobile into a Parking Area

In 420, Select Parking Space to Park

In 430, Receive Encoded Data

In 440, Decode Encoded Data

In 450, Display Decoded Data

In 452, Store Decoded Data

In 454, Data Retrieved and Displayed •

In 456, Automobile Located Using Retrieved Data

In 457, Pay For Parking

At 440, a parallel path is followed as follows.

In 460, Communications Established

In 462, Acknowledgment Transmitted

In 464, Establish Communications to Retrieve Stored Data

In 466, Data Retrieved

In some embodiments, the steps following block 440 are carried out sequentially.

At block 450, the decoded data is displayed. For example, the decoded data is displayed upon the cell phone or PDA's LCD screen for the user to review. The data is reviewed on the display and to ensure it is correct. An audible alert is associated with the display of the data to alert the person to review the data. The alert and display of the data may also serve as an indication that the data has been successfully decoded. In some embodiments, a warning tone and message is displayed to indicate the receiving or decoding of the data was unsuccessful. For example, the portable smart device 104 may sound a beep of a predetermined tone or a preset sound selected by the user to alert the person that the data has been decoded. A series of beeps is used to alert the person that an error has occurred with the data and the person should check the display for the specific error. For example, an error message may indicate that the image must be retaken of the QR code.

The display of the data may include the data decoded from encoded sign code 102. For example, the decoded data may consist of the location of the space. The data displayed may further comprise the address and the name of the parking area. The encoded sign code 102 may also be displayed. The data displayed may further consist of the time the data was recorded, e.g., the time the image was taken, which may relate to the time the person parked in the parking space. The time is imposed upon the data by the portable smart device 104.

At block 452, the decoded data is stored.

In some embodiments, the encoded sign code 102 received by the portable smart device 104 is stored in addition to the decoded data. Upon storage of the new encoded sign code 102, any prior encoded data is overwritten.

At block 454, the data is retrieved and displayed. For example, a person is walking back to the parking area and selects the parking data on the cell phone.

At block 456, the automobile is located using the retrieved data. For example, using the displayed parking space location information retrieved from the storage module 310, the person returns to their automobile by proceeding to the appropriate level and space number as displayed upon the portable smart device 104's display.

At block 460, communications is established. For example, the portable smart device 104 may establish communications with the server 110. The communication is automatically initiated by the portable electronic device. The communication attempt is in response to a manual selection from the person. The communication may occur over any of various means, such as through a phone number or wireless protocol. The phone number is toll-free, that no charges is incurred for using the phone number. For example, the portable electronic device places a call to the server 110 using a toll-free number over communications path 108. Upon successful establishment of communications with the server, the data is transmitted from the portable electronic device. The decoded data is transmitted. In some embodiments, the encoded data is transmitted. For example, the portable smart device 104 is communicatively coupled with the server 110. The portable smart device 104 sends and the server 110 receives the decoded data from the parking space. The transmission is conducted over the communications path 108.

At block 462, an acknowledgement is transmitted. This acknowledgement is transmitted from the server upon successful completion of the data transfer. For example, upon completion of the data transmission from the portable smart device 104 to the sever 110, the server 110 sends an acknowledgement to the portable smart device 104 which is sent over communications path 108. Upon receipt of the acknowledgement, the portable smart device 104 may display a message indicating successful transmission and may sound an audible beep using a predetermined or preselected tone. In some embodiments, only a message or a audible sound is used.

At block 464, communications is established to retrieve the stored data. The person may have to retrieve the stored data because of the inability to use the portable smart device 104 to retrieve and display the data. For example, the battery of the portable smart device 104 is dead from lack of charge. As a result, the person is unable to use the portable smart device 104 to retrieve and display the stored, parking space location data. The person may then use the alternate communications 118, such as a toll free dial in phone number or a website, to establish the communications path 116 with the server 110. For example, the parking area may have a computer terminal provided for this purpose that allows the person to access a website connected to the server 110.

At block 466, the data is retrieved. For example, the data is retrieved from the server 110 and transmitted from the server 110. The data is transmitted following the person entering the appropriate identification number or code which allows the server to retrieve the data stored in storage. Once the data is retrieved by the server, it is transmitted to the portable smart device 104. The transmitted data is in an audio or visual format, depending upon the method used to make the request to the server. For example, the person may have used a website as alternate communications 118 using the internet as the communication path 116 to access the server 110. The website may prompt the person to enter the identification code, such as the phone number for the portable smart device 104. Upon entering of the phone number, the server 110 may access storage 112 to retrieve the appropriate stored data associated with the portable smart device 104. Upon successful retrieval of the data, the server 110 may transmit the data over the communications path 116 to the website for display on the computer screen to the user.

Upon receiving the stored parking space data, the person may use the data to locate their automobile at block 456 as discussed above.

As shown in FIG. 1, the server 110 communicates the customer's geographical and personal data via link 120 to the merchants' marketing networks 122. This links merchants with customers who are using the parking locator services. This enables merchants to communicate with parking customers via link 124 to receive valuable discount coupons, information on store hours of operation, discount sales and special promotional events.

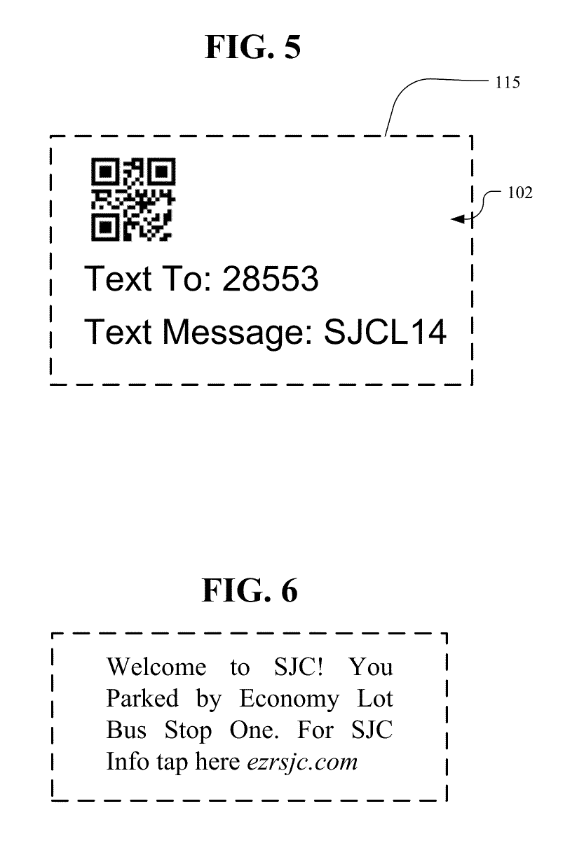

FIG. 5 depicts a typical code and texting display for texting to the server in the FIG. 1 system.

FIG. 6 depicts a returned text message in response to the transmitted message of FIG. 5

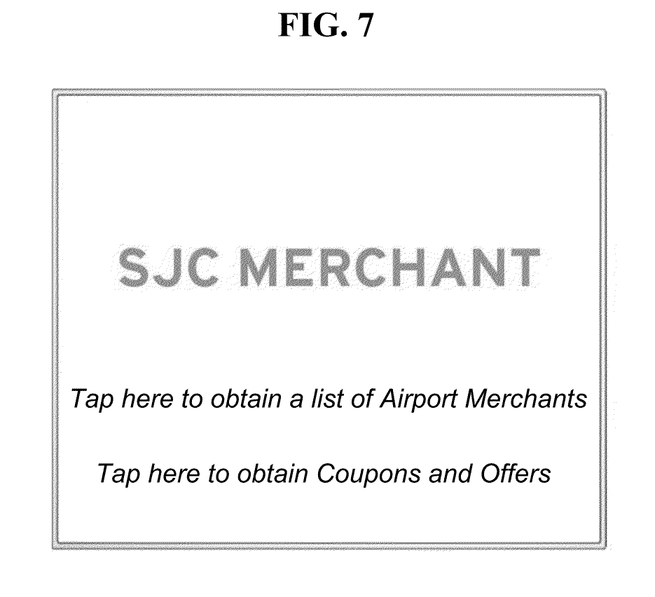

FIG. 7 depicts a first screen of data returned from the link ezrsjc.com in the message of FIG. 6.

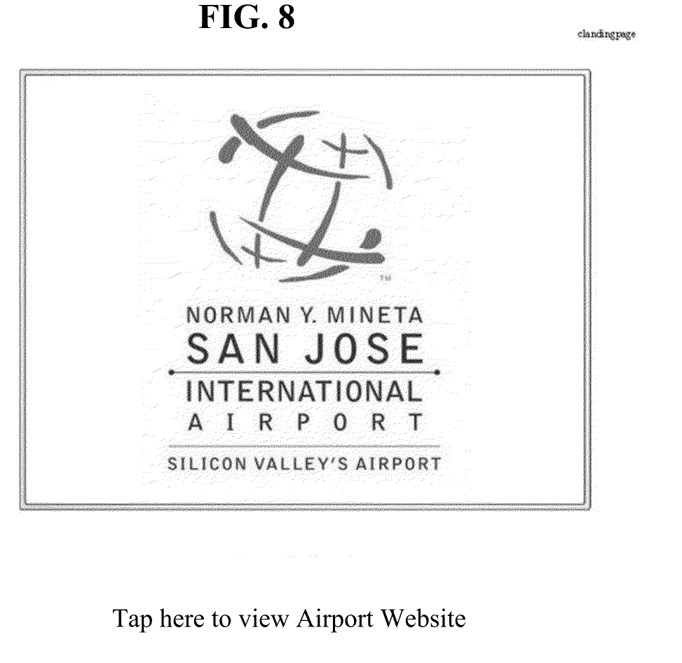

FIG. 8 depicts a second screen of data returned from the link ezrsjc.com in the message of FIG. 6

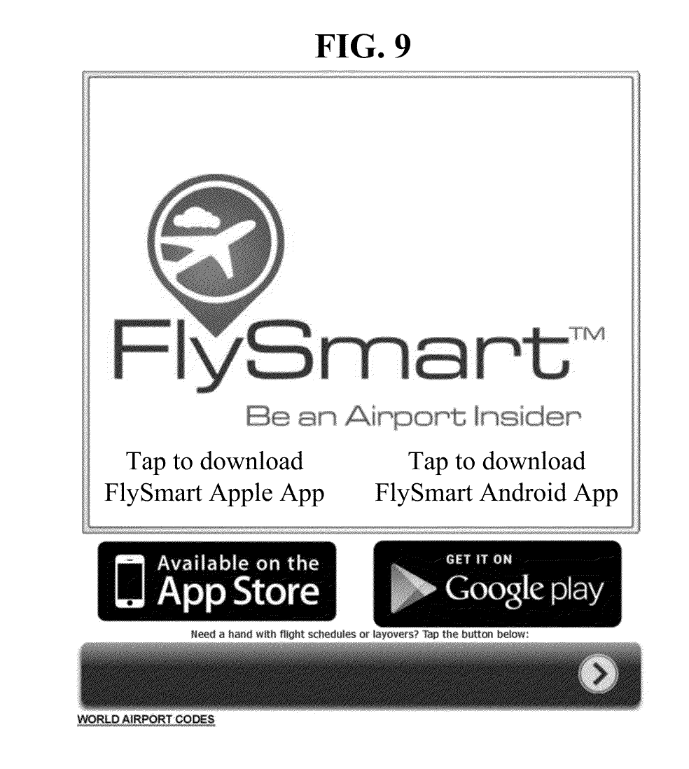

FIG. 9 depicts a third screen of data returned from the link ezrsjc.com in the message of FIG. 6

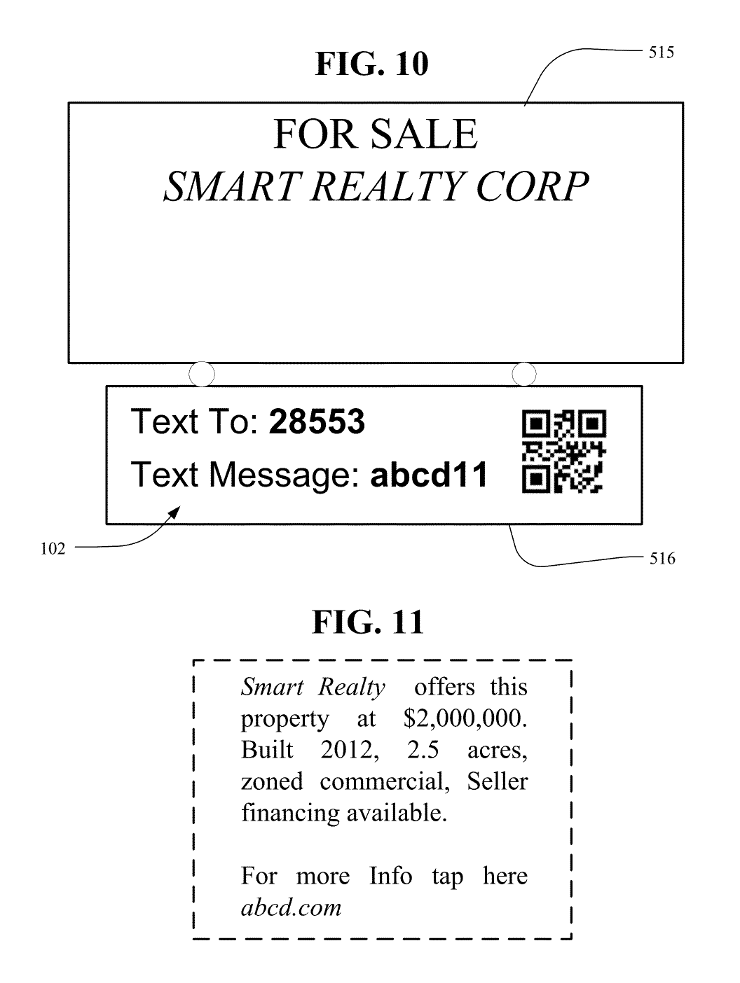

FIG. 10 depicts encoded data for use with a real estate embodiment of the FIG. 1 system.

FIG. 11 depicts a returned text message in response to the transmitted message of FIG. 10.

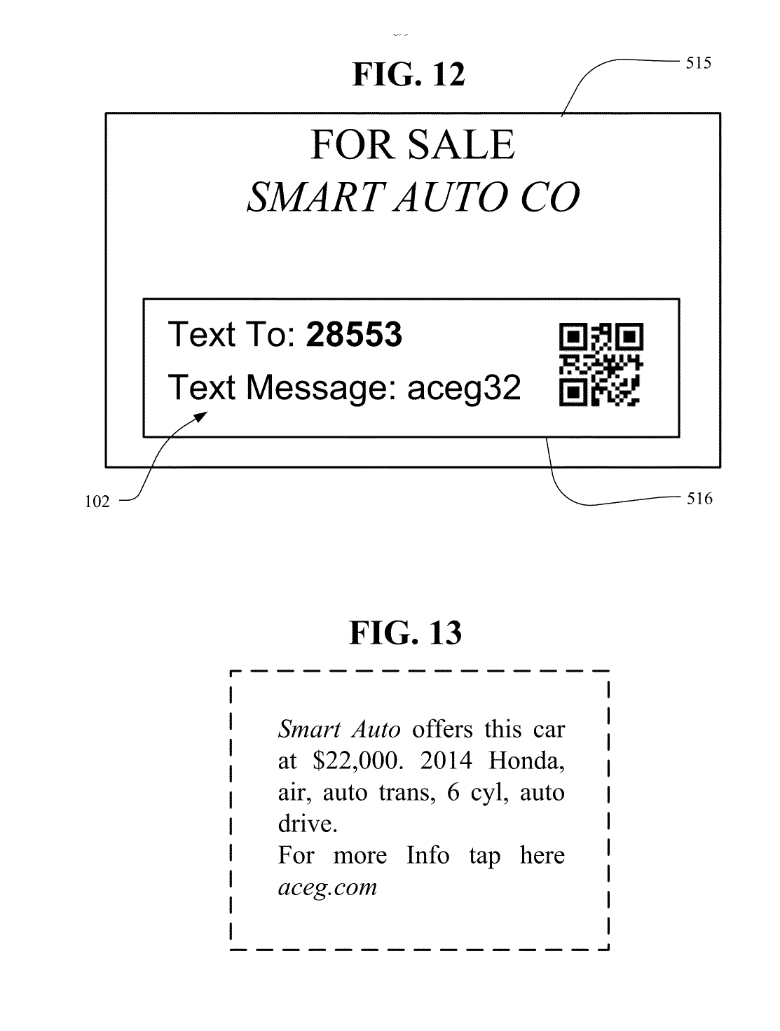

FIG. 12 depicts encoded data for use with an auto sale embodiment of the FIG. 1 system.

FIG. 13 depicts a returned text message in response to the transmitted message of FIG. 12.

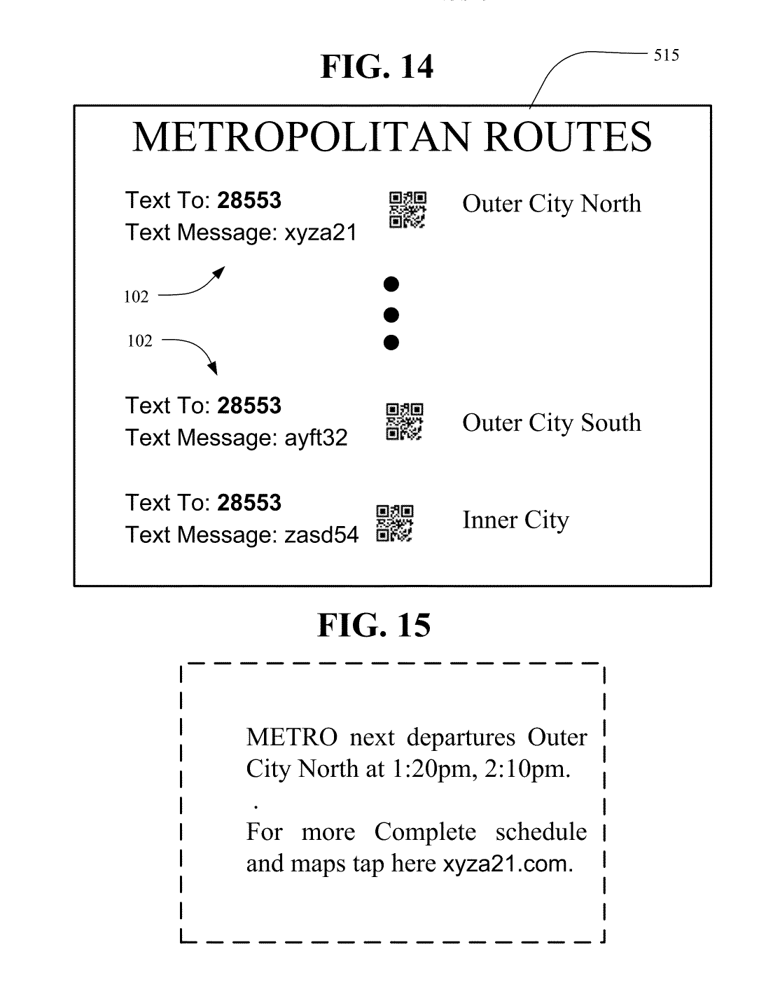

FIG. 14 depicts encoded data for use with a metropolitan transportation embodiment of the FIG. 1 system.

FIG. 15 depicts a returned text message in response to the transmitted message of FIG. 14.

A method in accordance with embodiments may allow a portable electronic device to obtain, process, display, and record encoded data associated with a parking space from a computer readable media, such as a bar code, affixed to or near the parking space. The computer readable media is of a suitable form which is capable of containing the encoded data. The data contained on the computer readable media may include the location of the parking space within a parking area. Other data is included, such as parking rate information and the physical address of the parking area. The location of the parking space may consist of such data to allow the person to find their automobile, such as a number associated with a parking space or the level and ROW Jocation of the parking space. The received data is processed by the portable electronic device. The processing by the portable electronic device may include decoding the data into a human-readable form, such as text or graphics. The decoded data is displayed on the portable electronic device. The decoded data may further be stored by the portable electronic device.

The portable electronic device may receive the data through various inputs, such as by using an optical imaging device, such as a digital camera or a scanner. The optical imaging device is contained within or associated with the portable electronic device. In some embodiments, the data is received through the use of an RFID chip, in place of or in conjunction with the optical imaging device. The data may also be received over a wireless signal broadcast from a wireless server associated with a parking space.

Both the received data and the processed data is stored on the portable electronic device. The stored data is retrieved by a person operating the portable electronic device. The retrieved data may then be displayed on the portable electronic device. Previous data for a parking space may also be erased from storage on the portable electronic device.

A server with associated storage is provided. The server is communicatively coupled with the portable electronic device. The encoded data from the parking space is transmitted from the portable electronic device to the server. The server may provide back-up storage of the data to allow recovery of the data in the event of a failure of the portable electronic device. The data transmitted between the portable electronic device and the server may include the received encoded data, the processed data, or a combination of both. The data stored by the server may include the received encoded data, the processed data, or a combination of both. The server may perform processing of the encoded data. The portable electronic device is communicatively coupled with the server over any suitable communications path, such as a wireless signal or a cellular signal.

The stored data is accessed by the server in response to a request to retrieve the stored data. The person may request retrieval of the stored data in the event of a failure of the portable electronic device. The person may also request retrieval of the stored data for any other reason wherein the person is unable to retrieve the stored data from the portable electronic device, i.e., the portable electronic device does not have to be inoperable. The request for retrieval of the stored data may come through any communications path, such as a toll free dial-in number or an internet based website. If the portable electronic device becomes operable following a failure, it may also be communicatively coupled with the server to request retrieval of the stored data and display it for the person.

The system implementing the method in accordance with embodiments may have components or modules associated with the portable electronic device to complete the steps of the method detailed above, such as receiving and processing of the data from the computer readable media associated with the parking space. The portable electronic device may also have communications capability to be communicatively coupled over a suitable path with a server to transmit the data. The portable electronic device may contain one or more processors. The one or more processors is dedicated to the processing of the data or the one or more processors is shared with other modules contained in the portable electronic device. The modules on the portable electronic device may include a data input module, an erasing module, a decoding module, a storage module, a display module, a transmit/receive module, a user interface module, and a payment module. Each module may perform a step or a series of steps involved in the processing of data associated with a parking space.

The invention in a preferred embodiment provides a method of reminding a driver of a parked vehicle of where the vehicle was parked, comprising: in a vicinity where a driver has parked a vehicle (such as within a range of about 50 feet or less of where a driver has parked vehicle), disposing a container from which is dispensed a physical item or electronic beam of data on which is stated or transmitted a location in which the vehicle has been parked, such as invention methods wherein the electronic beam of data utilizes infra-red or other applicable signal technology to transfer the parking location and other information directly to a vehicle parker's cell phone, PDA, or other similar device; invention methods wherein the physical item being dispensed is paper (such as methods wherein the physical item is caused to be dispensed by manually pressing a button or waving past a light, motion or other sensor; methods wherein a keypad receives input by a vehicle parker inputting a specific parking space designation, and the input is printed onto the dispensed paper which the vehicle parker receives to carry with him or her; methods wherein the dispensed paper includes both the location of the parked vehicle and a map and/or instructions indicating how to return to the parked vehicle). In a preferred embodiment, the emitted electronic transmission of information includes both the location of the parked vehicle and a map and/or instructions indicating how to return to the parked vehicle (and may include other more detailed information such as a guide to shops or commercial locations in the shopping destination, an electronic map, all on-going specials and other and other useful information), wherein the electronic beam is either continually emitted or is activated by manually pressing a button or waving past a light, motion or other sensor, and further wherein a keypad receives input by a vehicle parker inputting a specific parking space designation, and the input is encoded into the transmitting beam of information which the vehicle parker receives in his or her cell phone, PDA or other device.

In a preferred embodiment there shall be included the step in which the system is equipped to be programmed to provide advertisements, site-specific directions and other information.

In a preferred embodiment, the parked vehicle is parked in a parking garage or in an open-air parking lot, wherein multiple systems located within the same parking lot or garage area are capable of electronically locating each other in order to determine the three-dimensional layout of a parking area and the position of each locator device relative to others around it and to automatically print and/or transmit both the location of the car and a map and instructions indicating how to get from any point in the parking garage or lot to the area where a user's vehicle is located. In a preferred embodiment, a system component is installed in a retail or other commercial outlet and the vehicle parker is able to enter their parking location data manually on an external keypad or electronically and to receive back information on the shortest route to return to the original parking location from the current location.

While the invention has been shown and described with respect to a particular embodiment thereof, this is for the purpose of illustration rather than limitation; other variations and modifications of the specific embodiment herein shown and described will be apparent to those skilled in the art all within the intended spirit and scope of the invention. Accordingly, the patent is not to be limited in scope and effect to the specific embodiment shown and described or in any other way that is inconsistent with the extent to which the progress in the art has been advanced by the invention.

In the preceding specification, various embodiments have been described with reference to the accompanying drawings. It will, however, be evident that various modifications and changes is made thereto, and additional embodiments is implemented, without departing from the broader scope of the invention as set forth in the claims that follow. The specification and drawings are accordingly to be regarded in an illustrative rather than restrictive sense.

While the invention has been particularly shown and described with reference to preferred embodiments thereof it will be understood by those skilled in the art that various changes in form and details is made therein without departing from the scope of the invention.

1. A system for providing target information, comprising,
a smart sign having a sign code for use in accessing target information for an item at an identified location,
a smart device for,
inputting the sign code,
transmitting the sign code to a remote server, and
receiving a reply from the remote server to provide the target information.

2. The system of claim 1 wherein the sign code includes one or more of a Q-code, a bar code, an RFID code and a text code.

3. The system of claim 1 wherein the smart device is a smart phone, the transmission of the sign code is by a text transmission and the receiving of the target information is by a text transmission.

4. The system of claim 1 wherein the transmitting and receiving operations can be substantially delayed from the inputting operation so as to occur only when the smart device can communicate with the remote server.

5. The system of claim 1 wherein the target information includes a link for accessing further information.

6. The system of claim 1 wherein the smart sign is in a parking garage and the identified location is a parking stall for a vehicle.

7. The system of claim 1 wherein the smart sign is in a parking garage, the identified location is a parking stall for a vehicle and the target information includes a Web link for merchants interested in providing information to drivers parking in the parking garage.

8. The system of claim 1 wherein the smart sign is with a real estate sign for property at the identified location and the target information provides details about the real estate.

9. The system of claim 1 wherein the smart sign is with a vehicle at the identified location and the target information provides details about the vehicle.

10. The system of claim 1 wherein the smart sign is for transportation at the identified location and the target information provides details about the transportation.
